(19) United States
(12) Patent Application Publication
(10) Pub. No.: US 2005/0275864 A1
(43) Pub. Date: Dec. 15, 2005

(54) Image forming method and image forming apparatus

(75) Inventors: Toshihiko Sugimura, Kashiwara-shi (JP); Takao Fukuda, Yamatokoriyama-shi (JP); Hirokazu Izumi, Nara-shi (JP); Atsuo Tanaka, Nabari-shi (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/150,083

(22) Filed: Jun. 9, 2005

(30) Foreign Application Priority Data
Jun. 9, 2004 (JP) 2004-171827

(51) Int. Cl. G06F 15/00

(52) U.S. Cl. 358/1.13

(57) ABSTRACT

An image forming apparatus is provided which converts inputted data into image data for image formation and performs image forming on a sheet based on the converted image data, the apparatus including means for removably mounting a portable recording medium storing data and a program for converting the data into image data for image formation, means for reading the data and the program from the mounted portable recording medium, memory means for storing the read data and program, and means for executing the program to convert the data into image data for image formation.

### CROSS-REFERENCE TO RELATED APPLICATIONS

This Nonprovisional application claims priority under 35 U.S.C. § 119(a). on Patent Application No. 2004-171827 filed in Japan on Jun. 9, 2004, the entire contents of which are hereby incorporated by reference.

### BACKGROUND OF THE INVENTION

1. Field of the Invention

The present invention relates to an image forming method and an image forming apparatus for forming an image based on data stored in a portable recording medium.

2. Description of Related art

Conventionally, an image forming apparatus has been proposed which directly takes in image data stored in a portable recording medium such as a memory card without connecting to a host computer and performs printing based on the taken image data (for example, Japanese Patent Application Laid-Open No. 2003-127508 and No. 2004-42404). Such an image forming apparatus converts the taken image data into printable bitmap data and performs predetermined image processing such as the adjustment of print darkness and the adjustment of scale before performing image formation on a sheet. With such an apparatus, by storing image data obtained by image capturing using a digital camera, for example, into a portable recording medium, printing is possible even at a place away from home. Therefore, such an image forming apparatus is often installed in e.g. a convenience store or an electrical appliance store to provide users with a convenient printing environment. Further, by the provision of a communication interface, the image forming apparatus can be connected to a host computer to enable to execute printing, so that the apparatus can also be used in an office or home.

However, to execute printing by directly taking in image data stored in a portable recording medium, the image data needs to be stored in a predetermined file format. Specifically, the image forming apparatus includes a decoder for converting a particular file (JPEG file, for example) into bitmap data for printing. Therefore, although printing can be executed when the data file to be printed is stored in the predetermined format (JPEG format for example), the printing cannot be executed when the data file is stored in another file format (TIFF format or RAW data format, for example). Therefore, depending on the recording format of the image data, the data needs to be converted, in advance, into the predetermined file format by using e.g. a personal computer, which is difficult for people who are inexperienced in the operation of a personal computer and is also troublesome for experienced people.

Further, there is a strong demand for the environment which is able to perform printing of not only image data but also data formed by a certain application program such as text data and graphics data at a place away from home. However, such an image forming apparatus has not yet been proposed.

Moreover, since the content printed out at a place away from home often includes personal information, it is desired to delete the data after the completion of printing to prevent information from leaking.

### BRIEF SUMMARY OF THE INVENTION

The present invention has been made with the aim of solving the above problems, and it is an object of the present invention to provide an image forming method and image forming apparatus which are capable of executing printing of data of a format other than a predetermined format by reading data and a program for converting the data into image data for image formation from a portable recording medium storing the data and the program and performing image formation on a sheet after converting the data into image data for image formation.

Another object of the present invention is to provide an image forming apparatus which is capable of deleting the read data when the image forming is determined to be completed to prevent information from leaking.

An image forming method according to the present invention performs image forming by receiving data at an image forming apparatus, converting the received data into image data for image formation and performing image forming on a sheet based on the converted image data. The image forming method is characterized in that data and a program for converting the data into image data for image formation is read from a portable recording medium storing the data and the program, the read program is executed to covert the data into image data for image formation, and image forming on a sheet is performed based on the converted image data.

In the present invention, data and a program for converting the data into image data for image formation is read from a portable recording medium storing the data and the program, and image forming on a sheet is performed based on the image data obtained by the conversion. Therefore, it is not necessary to read data in a predetermined file format, so that printing of data formed by an arbitrary application program is possible.

An image forming apparatus according to the present invention coverts inputted data into image data for image formation and performs image forming on a sheet based on the converted image data. The image forming apparatus is characterized in that the apparatus includes means for removably mounting a portable recording medium storing data and a program for converting the data into image data for image formation, means for reading the data and the program from the mounted portable recording medium, memory means for storing the read data and program, and means for executing the program to convert the data into image data for image formation.

In the present invention, data and a program for converting the data into image data for image formation is read from a portable recording medium storing the data and the program, and image forming on a sheet is performed based on the image data obtained by the conversion. Therefore, a conversion program and a decoder for adaptation to various data formats need not be incorporated. Further, it is not necessary to read data in a predetermined file format, so that printing of data formed by an arbitrary application program is possible.

The image forming apparatus according to the present invention includes means for determining whether or not image forming based on the image data is completed, and means for deleting the data stored in the memory means when the image forming is determined to be completed.

In the present invention, the read data is deleted when the image forming is determined to be completed, so that data is prevented from leaking.

The image forming apparatus according to the present invention includes means for deleting the program stored in the memory means when the image forming is determined to be completed.

In the present invention, when the image forming is determined to be completed, the conversion program which is read is deleted. Therefore, it is possible to deal with data formed by various kinds of application programs without increasing the capacity of the memory means.

The image forming apparatus according to the present invention includes means for giving a notice to remove the portable recording medium when the data and the program are read from the portable recording medium.

In the present invention, when reading of the data and the program is completed, a notice to remove the portable recording medium is displayed. Therefore, the portable recording medium is prevented from being left.

The image forming apparatus according to the present invention includes means for detecting removal of the portable recording medium, and the program is executed after the removal of the portable recording medium is detected.

In the present invention, the program for conversion is executed after the removal of the portable recording medium is detected. Therefore, the portable recording medium is removed before the printing is performed, whereby the portable recording medium is prevented from being left.

The image forming apparatus according to the present invention further includes means for determining existence or absence of an executable program in the mounted portable recording medium, and means for stopping reading of data from the portable recording medium when it is determined that an executable program does not exist.

In the present invention, determination is made as to whether or not an executable program exists in the mounted portable recording medium, and the reading of data is stopped when it is determined that an executable program does not exist. Therefore, reading of unnecessary data is avoided, whereby the processing time can be shortened. Further, information leaks can be minimized.

The image forming apparatus according the present invention includes means for transmitting the converted image data to the outside.

In the present invention, means for transmitting the converted image data to the outside is provided. Therefore, the apparatus can be applied to a facsimile machine and a multi-function printer, for example.

The image forming apparatus according to the present invention includes means for displaying the converted image data.

Since the apparatus of the present invention includes means for displaying the converted image data, it is possible to make the user confirm the content to be printed.

According to the present invention, data and a program for converting the data into image data for image formation is read from a portable recording medium storing the data and the program, and image forming on a sheet is performed based on the image data obtained by the conversion. Therefore, it is not necessary to read data in a predetermined file format, so that printing of data formed by an arbitrary application program is possible

According to the present invention, data and a program for converting the data into image data for image formation is read from a portable recording medium storing the data and the program, and image forming on a sheet is performed based on the image data obtained by the conversion. Therefore, a conversion program and a decoder for adaptation to various data formats need not be incorporated. Further, since it is not necessary to read data in a predetermined file format, printing of data formed by an arbitrary application program is possible, whereby it is possible to provide users with a convenient printing environment.

According to the present invention, the read data is deleted when the image forming is determined to be completed, so that data is prevented from leaking.

According to the present invention, when the image forming is determined to be completed, the conversion program which is read is deleted. Therefore, it is possible to deal with data formed by various kinds of application programs without increasing the capacity of the memory means. Moreover, printing can be performed even when the data is not recorded in a predetermined file format.

According to the present invention, when reading of the data and the program is completed, a notice to remove the portable recording medium is displayed. Therefore, the portable recording medium is prevented from being left.

According to the present invention, the program for conversion is executed after the removal of the portable recording medium is detected. Therefore, the portable recording medium is removed before the printing is performed, whereby the portable recording medium is prevented from being left.

According to the present invention, determination is made as to whether or not an executable program exists in the portable recording medium, and the reading of data is stopped when it is determined that an executable program does not exist. Therefore, reading of unnecessary data is avoided, whereby the processing time can be shortened. Further, information leaks can be minimized.

According to the present invention, means for transmitting the converted image data to the outside is provided. Therefore, the apparatus can be applied to a facsimile machine and a multi-function printer, for example.

According to the present invention, means for displaying the converted image data is provided. Therefore, it is possible to make the user confirm the content to be printed.

### BRIEF DESCRIPTION OF THE SEVERAL VIEWS OF THE DRAWINGS

FIG. 1 is a block diagram explaining the internal structure of an image forming apparatus according to the present invention;

FIG. 2 is a flowchart explaining the process steps performed by the image forming apparatus;

FIG. 3 is a flowchart explaining the process steps performed by the image forming apparatus;

FIG. 4 is a flowchart explaining the process steps performed by the image forming apparatus;

FIGS. 5A and 5B are schematic views showing examples of screens displayed at a display section of the operating panel;

FIGS. 6A and 6B are schematic views showing examples of screens displayed at a display section of the operating panel; and

FIGS. 7A and 7B are schematic views showing examples of screens displayed at a display section of the operating panel.

### DETAILED DESCRIPTION OF THE INVENTION

The present invention will be described below in detail with reference to the drawings showing the embodiments.

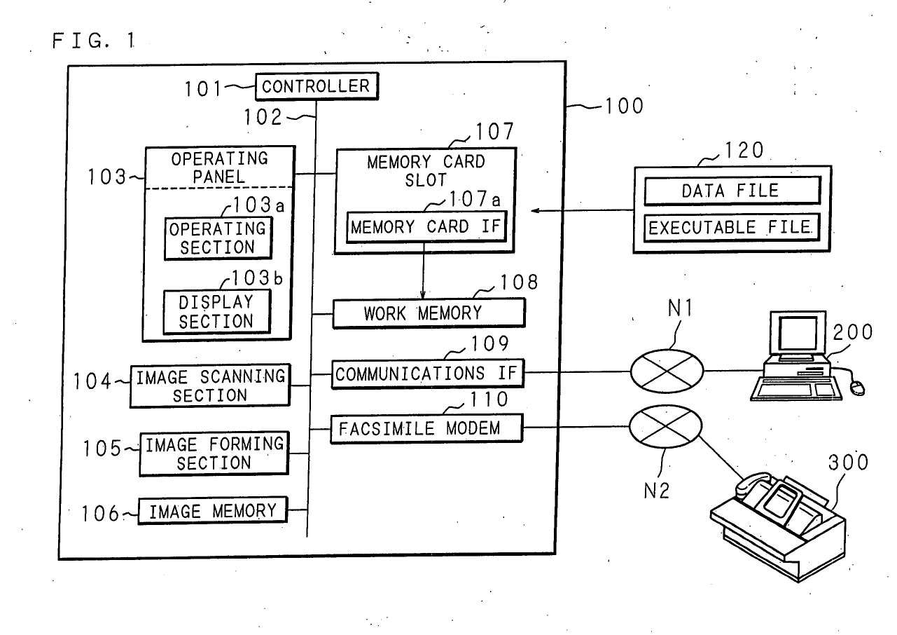

FIG. 1 is a block diagram explaining the internal structure of an image forming apparatus according to the present invention. In FIG. 1, the reference numeral 100 represents is an image forming apparatus having a print function to receive a print job from the outside and form an image on a sheet such as paper or OHP film, a copy function to scan an image of a document and form an image on a sheet, a facsimile transmission function to scan an image of a document and transmit facsimile data to the outside, and an image transmission function to transmit image data to an external apparatus. The image forming apparatus 100 is connected to an information processor 200 such as a personal computer through a communication network N1 and connected to a facsimile machine 300 through a public telephone network N2.

In the information processor 200 are installed, in advance, an application program for forming electronic data such as documents and graphics and a driver program (printer driver) for sending the processing instructions (print job) to the image forming apparatus 100 through the communication network N1. Therefore, the printing of documents and graphics, for example, can be executed by calling the printer driver from the application program and transmitting the print job created by the printer driver to the image forming apparatus 100.

The facsimile machine 300 has a function to encode and decode image data by a predetermined system and is capable of transmitting and receiving the facsimile data obtained by encoding through the public telephone network N2. Specifically, the facsimile data received through the public telephone network N2 is decoded to form an image based on the obtained image data, and the image data to be transmitted is encoded and then transmitted to the image forming apparatus 100.

The image forming apparatus 100 of this embodiment is capable of reading data stored in a memory card 120 which is a portable recording medium, converting the read data into image data for printing (hereinafter, simply referred to as print data) and performing image forming based on the print data obtained by the conversion. The data to be converted (data file) and a conversion program (executable file) for converting the data into print data are stored in the memory card 120 in advance. Upon reading the data file and the executable file, the image forming apparatus executes the executable file, generates print data from the data file, and performs printing based on the produced print data. It is to be noted that, in the above-described data, the data produced by an arbitrary commercial application is included in addition to text data and image data. For example, the conversion program may be provided by the manufacturer or distributor of the image forming apparatus 100 as a CD-ROM or by downloading through the Internet network.

The control system of the image forming apparatus 100 will be described below.

The image forming apparatus 100 includes a controller 101. The controller 101 controls various kinds of hardware connected through a bus 102 to make the apparatus function as the image forming apparatus of the present invention as a whole. For this purpose, the controller 101 includes a CPU, a ROM in which a control program for controlling various kinds of hardware is stored in advance, and a RAM for temporarily storing data generated in executing the control program, for example.

An operating panel 103 comprises an operating section 103a for receiving operation instructions from the user and a display section 103b for displaying information to be notified to the user. The operating section 103a is provided with various kinds of keys for receiving operation instructions from the user. Thus, the operating section 103a receives the user's instructions to change settings such as the number of print copies, the darkness of copying and the transmission destination of facsimile data, to change the functions, and to start the outputting, for example. The display section 103b is provided with a liquid crystal display and displays the operating condition of the image forming apparatus 100, various kinds of settings inputted through the operating section 103a and information to be notified to the user, for example. Part of the display section 103b is provided with software keys of a touch panel type for receiving various kinds of selecting operations.

An image scanning section 104 includes a light source for emitting light to a document to be read, an image sensor such as a CCD (Charge Coupled Device) and an A/D converter (not shown), for example. The image reading section forms an image of a document set at a predetermined reading position onto the image sensor to convert the image into analog electrical signals and performs AD conversion of the obtained analog electrical signals by the AD converter. The digital signals obtained by AD conversion are subjected to correction related to the light distribution characteristics of the light source in reading the image and the variation in sensitivity of the image sensor, for example, whereby digital image data is obtained.

An image forming section 105 comprises, for example, a charger for charging a photosensitive drum to a predetermined potential, a laser writing device for emitting laser beams in accordance with the image data received from the outside to form an electrostatic latent image on the photosensitive drum, a developer for supplying toner to the electrostatic latent image formed on the photosensitive drum to develop the image, and a transfer unit for transferring the toner image formed on the photosensitive drum surface to a sheet (not shown). The image forming section 105 forms an image desired by the user on a sheet by electrophotography.

Although the structure provided with an image forming section 105 for forming an image by electrophotography is exemplarily described, the structure may be provided with an image forming unit for forming an image by the inkjet system, thermal transfer system or sublimation system.

An image memory 106, which comprises a semiconductor memory, temporarily stores the image data generated by reading an image of a document by the image scanning section 104, the image data extracted from the print job received through a communications IF 109, and the image data extracted from the facsimile data received through a facsimile modem 110. The image data temporarily stored in the image memory 106 is transferred to the transfer destination in accordance with the purpose of use by the instruction of the controller 101.

A memory card slot 107, which is the means for mounting a memory card 120, is provided with a memory card IF 107a which includes a detection circuit for detecting whether or not the mounting is performed and an interface circuit for performing reading and writing of data with respect to the mounted memory card 120. The data read or to be written via the memory card IF 107a is temporarily stored in a work memory 108 (memory means) which is a volatile memory.

The communications IF 109, which is provided with an interface meeting the communications standards of the communication network N1, receives a print job from the information processor 200 connected to the communication network N1 and transmits information to the information processor 200 as required. In the communications IF 109, the transmitting and receiving of data is controlled.

The facsimile modem 110 is provided with a line termination circuit for connection to the public telephone network N2 and receives the facsimile data transmitted to the image forming apparatus 100 through the public telephone network N2. The facsimile modem 110 includes a decoding circuit for decoding the received facsimile data and transfers the image data obtained by decoding to the image forming section 105 via the image memory 106 to perform printing of the facsimile data on a sheet. The facsimile modem 110 further includes an encoding circuit for encoding the facsimile data to be transmitted and transmits the facsimile data encoded by the encoding circuit to an intended facsimile machine (e.g. the facsimile machine 300).. The facsimile modem 110 performs the transmitting and receiving of facsimile data and the encoding and decoding process of the facsimile data.

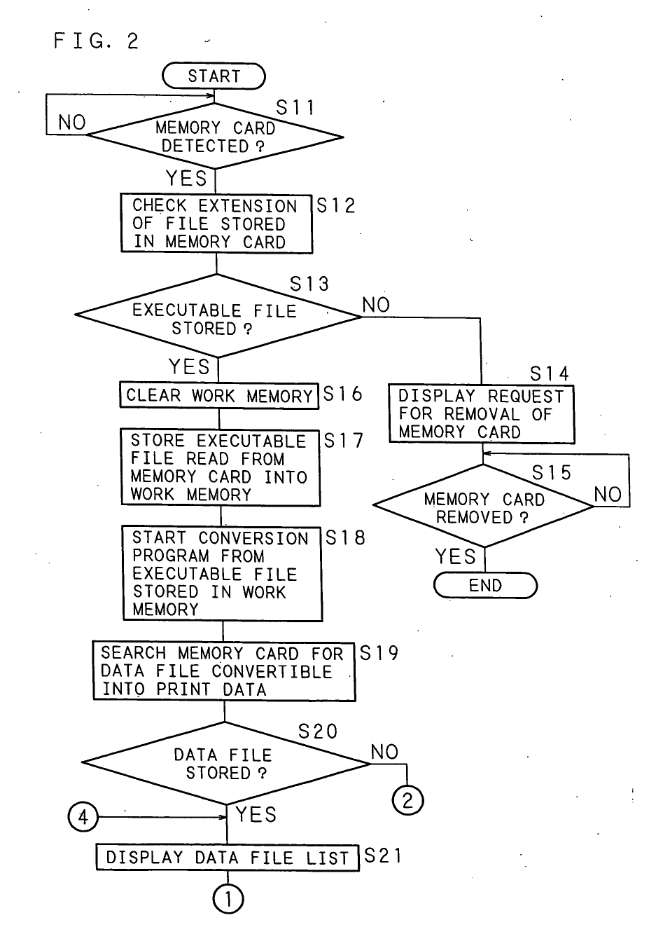

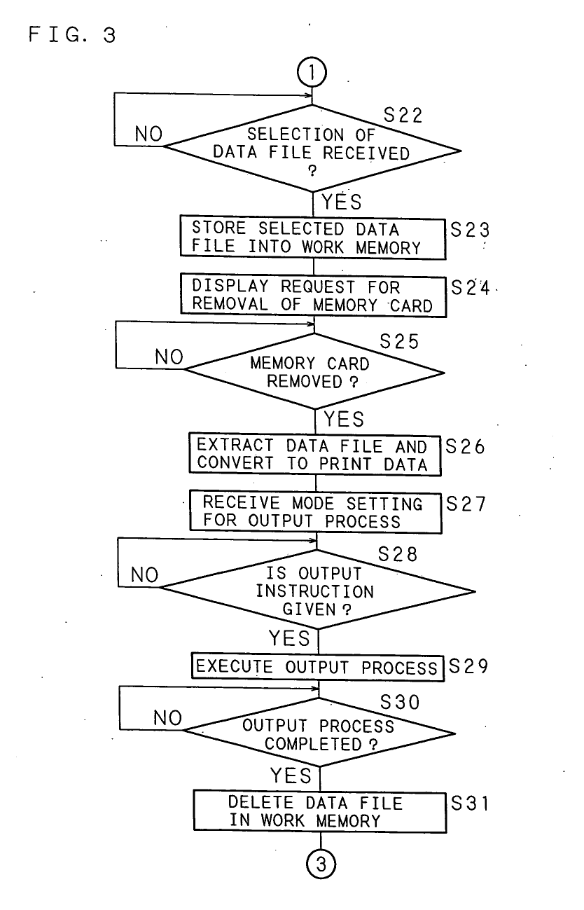

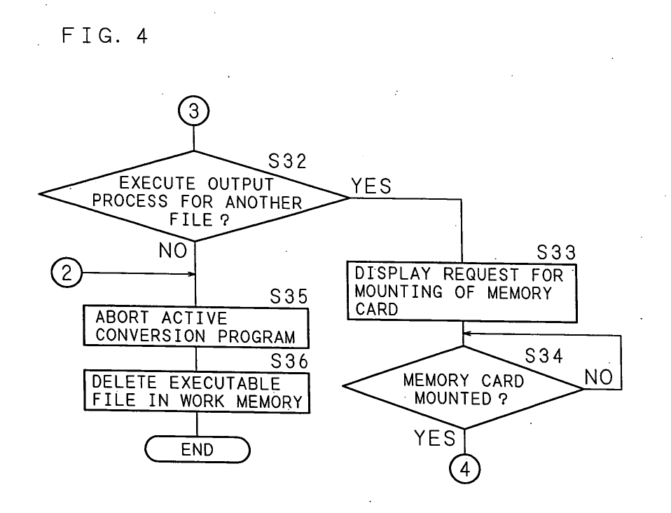

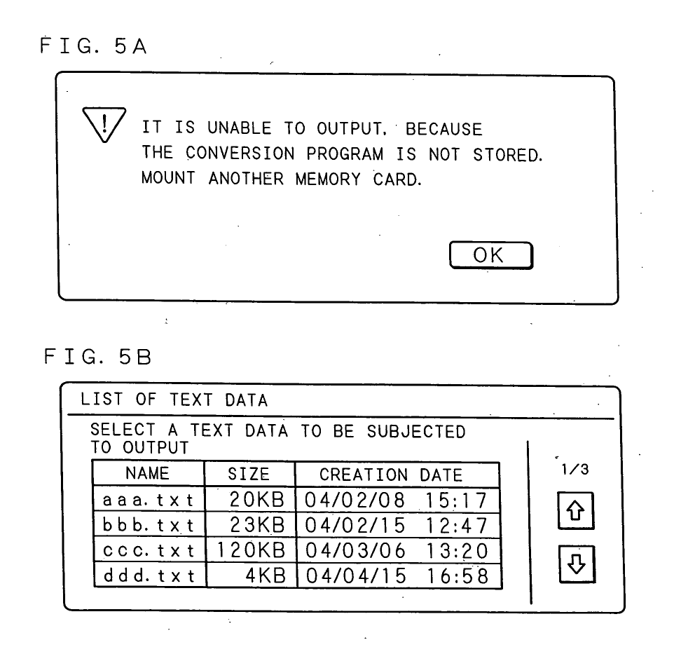

The processing performed by the image forming apparatus 100 will be described below with reference to the flowcharts and examples of screens displayed at the display section 103b of the operating panel 103. FIGS. 2-4 are flowcharts explaining the process steps performed by the image forming apparatus 100, whereas FIGS. 5-7 are schematic views explaining examples of screens displayed at the display section 103b of the operating panel 103. First, the controller 101 of the image forming apparatus 100 determines whether or not the memory card 120 mounted to the memory card slot 107 is detected (Step S11). When the memory card 120 mounted to the memory card slot 107 is not detected (S11: NO), the controller waits until the memory card 120 is detected.

When it is determined that the memory card 120 mounted to the memory card slot 107 is detected (S11: YES), the extension of the file stored in the memory card 120 is checked (Step S12), and whether or not an executable file is stored is determined (Step S13). When it is determined that an executable file is not stored (S13: NO), the removal of the memory card 120 is requested by displaying a screen as shown in FIG. 5A at the display section 103b of the operating panel 103 (Step S14). Then, the controller 101 monitors the output of the memory card IF 107a to determine whether or not the memory card 120 is removed (Step S15). When it is determined that the memory card 120 is not removed (S15: NO), the controller waits until the memory card 120 is removed. When the memory card 120 is removed (S15: YES), the processing of the flowchart is finished.

When it is determined that an executable file is stored in the memory card 120 in step S13 (S13: YES), the work memory 108 is cleared (Step S16) to secure a predetermined storage capacity. The clearing of the work memory 108 may be performed by writing zeroes in the storage area or by deleting the control table controlling the data writing position.

Subsequently, the executable file read from the memory card 120 is stored in the work memory 108 (Step S17) and a conversion program is started up from the executable file stored in the work memory 108 (Step S18). Then, the memory card 120 is searched for a data file which can be converted into print data (Step S19), and determination is made as to whether or not a data file which can be converted into print data is stored (Step S20). Whether a data file can be converted into print data or not can be determined based on the extension. For example, when the executable file stored in Step S17 is a conversion program for converting text data into print data, whether or not text data is stored in the memory card 120 is checked.

When it is determined that a data file which can be converted into print data is stored in the memory card 120 (S20: YES), a screen as shown in FIG. 5B is displayed at the display section 103b of the operating panel 103 to display the list of data files (Step S21). The example of a screen as shown in FIG. 5B indicates the list of text data. The list includes a plurality of records each comprising information as to the name, size and creation date of a data file associated with each other. A software button of a touch panel type is provided at a position corresponding to the display position of each record so that a user can select the data file to be outputted by pressing the button. On the right side of the display is provided a page change button so that other selection options can be displayed.

Subsequently, the controller 101 monitors the output from the operating panel 103 to determine whether or not the selection of the data file is received (Step S22). When it is determined that the selection of the data file is not received (S22: NO), the controller waits until the selection is received. When the selection of the data file is determined to be received (S22: YES), the selected data file is read and stored in the work memory 108 (Step S23).

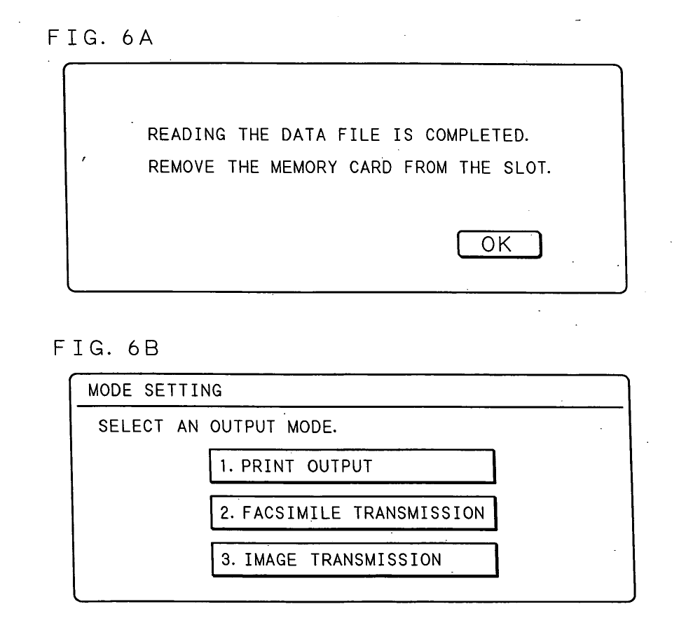

Then, the removal of the memory card 120 is requested by displaying a screen as shown in FIG. 6A at the display section 103b of the operating panel 103 (Step S24). Subsequently, the controller 101 monitors the output of the memory card IF 107a to determine whether or not the memory card 102 is removed (Step S25). When it is determined that the memory card 120 is not removed (S25: NO), the controller waits until the memory card 120 is removed. When the memory card 120 is determined to be removed (S25: YES), the data file stored in the work memory 108 is extracted and converted into print data (Step S26). Then, the print data obtained by the conversion is displayed as an image data at the display section 103b of the operating panel 103 to make the user confirm the content of the print.

Subsequently, such a screen as shown in FIG. 6B is displayed at the display section 103b of the operating panel 103 to receive mode setting for the output process (Step S27). In this embodiment, as the mode for the output process, selection can be made from the print output mode for forming an image on a sheet, a facsimile transmission mode for transmitting to the external facsimile machine 300 after conversion into facsimile data, and an image transmission mode for transmission image data to the information processor 200 through the communication network N1. At this time, settings of the number of print copies, darkness of printing and output destination address, for example, may be received as well.

Subsequently, the controller 101 determines whether or not an output instruction is given by the user through the operating panel 103 (Step S28). When it is determined that the output instruction is not provided (S28: NO), the controller waits until the output instruction is given. When it is determined that the output instruction is given (S28: YES), the output process is executed at the mode received in Step S27 (Step S29). Specifically, in the case where the print output mode is selected, the print data temporarily stored in the work memory 108 is transferred to the image forming section 105 to form an image on a sheet. In the case where the facsimile transmission mode is selected, the print data is encoded for conversion into facsimile data and transmitted to the facsimile machine 300 through the facsimile modem 110. In the case where the image transmission mode is selected, the print data is transmitted to the information processor 200 through the communications IF 109.

Subsequently, the controller 101 determines whether or not the output process is completed (Step S30). When it is determined that the output process is not completed (S30: NO), the controller 101 waits until the output process is completed. When it is determined that the output process is completed (S30: YES), the data file is deleted from the work memory 108 (Step S31). The deletion of the data file may be performed by overwriting the storage area storing the data file with zeroes or random data or by deleting the control table controlling the writing position of the data file.

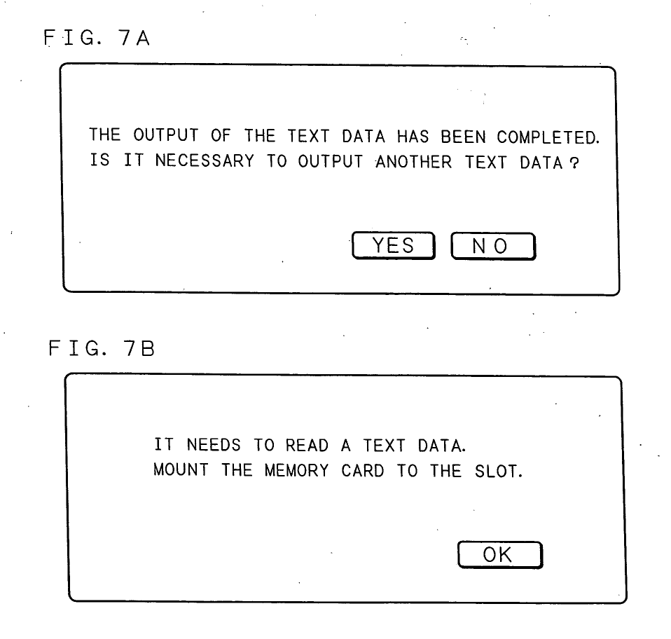

When the deletion of the data file from the work memory 108 is completed, such a screen as shown in FIG. 7A is displayed at the display section 103b of the operating panel 103 to ask the user whether to execute the output process for other data (text data) or not. Based on the user's instruction given through the screen, the controller 101 determines whether or not to execute the output process for another data file (Step S32). When it is determined to execute the output process of another data file (S32: YES), mounting of the once-removed memory card 120 is requested by displaying a screen as shown in FIG. 7B at the display section 103b of the operating panel 103 (Step S33). Then, the controller 101 monitors the output of the memory card IF 107a to determine whether or not the memory card 120 is mounted (Step S34). When it is determined that the memory card 120 is not mounted (S34: NO), the controller 101 waits until the memory card 120 is mounted. When it is determined that the memory card 120 is mounted (S34: YES), the process returns to Step S21 to perform the process steps such as the selection of a data file to be outputted and the outputting of the selected data file.

When it is determined, in Step S32, that the output process for another data file is not to be executed (S32: NO), the active conversion program is aborted (Step S35), and the executable file temporarily stored in the work memory 108 is deleted (Step S36). The deletion of the executable file may be performed by overwriting the storage area storing the executable file with zeroes or random data or by deleting the control table controlling the writing position of the data file.

On the other hand, when it is determined, in Step S20, that a data file which can be converted is not stored in the mounted memory card 120 (S20: NO), the active conversion program is aborted (S35), and the executable file temporarily stored in the work memory 108 is deleted (Step S36).

In this embodiment, the output process of data files is executed with respect to each file. However, when a plurality of data files which can be converted by the above-described conversion program are stored in the memory card 120, the data files may be taken into the work memory 108 at a time, and the data files stored in the work memory 108 may be deleted after the output process of all the data files are completed.

Further, although a card-type portable recording medium is used in this embodiment, the present invention is not limited to the such a card-type portable recording medium. In the present invention, a data file and an executable program may be taken in by combining a flexible disk using a magnetic disk, a disk-type portable recording medium such as CD-R and DVD-R, or a portable recording medium such as a USB memory with a reading apparatus thereof As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. An image forming method comprising the steps of:
reading data and a program for converting the data into image data for image formation from a portable recording medium storing the data and the program;
executing the read program to covert the data into image data for image formation; and
performing image forming on a sheet based on the converted image data.

2. An image forming apparatus comprising:
a mount section for removably mounting a portable recording medium storing data and a program for converting the data into image data for image formation; and
a controller capable of performing operations of;
reading the data and the program from the portable recording medium mounted to the mount section;
storing the read data and program in a memory;
executing the program to convert the data into image data for image formation; and
performing image forming on a sheet based on the converted image data.

3. The image forming apparatus according to claim 2, wherein said controller is further capable of performing an operation of determining whether or not image forming based on the image data is completed; and
deleting the data stored in the memory when the image forming is determined to be completed.

4. The image forming apparatus according to claim 3, wherein said controller is further capable of performing an operation of deleting the program stored in the memory when the image forming is determined to be completed.

5. The image forming apparatus according to claim 2, wherein said controller is further capable of performing an operation of giving a notice to remove the portable recording medium when the data and the program are read from the portable recording medium.

6. The image forming apparatus according to claim 2, wherein said controller is further capable of performing operations of detecting removal of the portable recording medium; wherein the program is executed after the removal of the portable recording medium is detected.

7. The image forming apparatus according to claim 2, wherein said controller is further capable of performing operations of determining existence or absence of an executable program in the mounted portable recording medium; and
stopping reading of data from the portable recording medium when it is determined that an executable program does not exist.

8. The image forming apparatus according to claim 2, wherein said controller is further capable of performing an operation of transmitting the converted image data to a transmission section.

9. The image forming apparatus according to claim 2, wherein said controller is further capable of performing an operation of displaying the converted image data at a display section.

10. An image forming apparatus comprising:
means for removably mounting a portable recording medium storing data and a program for converting the data into image data for image formation;
means for reading the data and the program from the mounted portable recording medium;
memory means for storing the read data and program;
means for executing the program to convert the data into image data for image formation; and
means for performing image forming on a sheet based on the converted image data.

11. The image forming apparatus according to claim 10, further comprising means for determining whether or not image forming based on the image data is completed; and
means for deleting the data stored in the memory means when the image forming is determined to be completed.

12. The image forming apparatus according to claim 11, further comprising means for deleting the program stored in the memory means when the image forming is determined to be completed.

13. The image forming apparatus according to claim 10, further comprising means for giving a notice to remove the portable recording medium when the data and the program are read from the portable recording medium.

14. The image forming apparatus according to claim 10, further comprising means for detecting removal of the portable recording medium; wherein the program is executed after the removal of the portable recording medium is detected.

15. The image forming apparatus according to claim 10, further comprising means for determining existence or absence of an executable program in the mounted portable recording medium; and
means for stopping reading of data from the portable recording medium when it is determined that an executable program does not exist.

16. The image forming apparatus according to claim 10, further comprising means for transmitting the converted image data to outside.

17. The image forming apparatus according to claim 10, further comprising means for displaying the converted image data.
